(19) United States
(12) Patent Application Publication
(10) Pub. No.: US 2020/0168989 A1
(43) Pub. Date: May 28, 2020

(54) ANTENNA DEVICE, ANTENNA CONTROL DEVICE, AND METHOD FOR CONTROLLING ANTENNA DEVICE

(71) Applicant: MITSUBISHI ELECTRIC CORPORATION, Chiyoda-ku (JP)

(72) Inventors: Takayuki FUKUI, Chiyoda-ku (JP); Yasushi HORIUCHI, Chiyoda-ku (JP); Munetaka KASHI WA, Chiyoda-ku (JP)

(73) Assignee: MITSUBISHI ELECTRIC CORPORATION, Chiyoda-ku (JP)

(21) Appl. No.: 16/484,360

(22) PCT Filed: Feb. 16, 2018
(86) PCT No.: PCT/JP2018/005474

§ 371 Date: Aug. 7, 2019

(30) Foreign Application Priority Data
Feb. 17, 2017 (JP) 2017-028034

(51) Int. Cl. H01Q 3/08; H01Q 1/27; H01Q 1/12; H01Q 15/16

(52) U.S. Cl. CPC H01Q 3/08; H01Q 15/16; H01Q 1/125; H01Q 1/27

(57) ABSTRACT

An azimuth support is rotatable around an azimuth axis. An elevation support is rotatable around an elevation axis. An auxiliary support is rotatable around an auxiliary axis that is perpendicular to the elevation axis. An antenna control device calculates a command orientation direction that is a direction in which a parabolic antenna is oriented. At initial capture of a communication target, the antenna control device sets an original point of an auxiliary axis to a midpoint of a rotation range of the auxiliary axis and sets an original point of an azimuth axis and an original point of an elevation axis to an azimuth angle and an elevation angle of the command orientation direction. The antenna control device calculates a drive command value indicating amounts by which the azimuth support, the elevation support, and the auxiliary support are driven so that (i) the parabolic antenna directs in the command orientation direction and (ii) a sum of amounts of change of the azimuth axis, the elevation axis, and the auxiliary axis from the original point is minimized. The antenna control device controls the azimuth support, the elevation support, and the auxiliary support in accordance with the drive command value.

### TECHNICAL FIELD

The present disclosure relates to an antenna device, an antenna control device, and a method for controlling the antenna device.

### BACKGROUND ART

Radio communication between an artificial satellite and a terrestrial base station using an antenna having directivity such as a parabolic antenna involves controlling the antenna to direct to and track a communication target. Cooperative control is known as one of methods for controlling the antenna, and examples of the cooperative control are described in Patent Literature 1 and Patent Literature 2.

Patent Literature 1 describes a capturing and tracking control device having two driving mechanisms, a coarse driving mechanism and a fine driving mechanism, in orientation angle control for an optical antenna in optical communications used in a mobile object.

Patent Literature 2 describes an antenna control device for satellite tracking. This control device calculates an azimuth angle and an elevation angle directed to a satellite in a mobile object-fixed coordinate system, detects an azimuth angle and an elevation angle of an antenna in a gimbal coordinate system by driving the antenna toward a direction in which a level of a received signal peaks, computes an axial-discrepancy amount, and commands changing of the axial-discrepancy amount.

### CITATION LIST

### Patent Literature

Patent Literature 1: Unexamined Japanese Patent Application Kokai Publication No. 2012-253484

Patent Literature 2: Unexamined Japanese Patent Application Kokai Publication No. 2003-37424

### SUMMARY OF INVENTION

### Technical Problem

In conventional cooperative control, an antenna is controlled to be driven to minimize an amount of change from the original point of a coordinate system specific to an antenna device. In mobile communications in which communication is made using a mobile object equipped with an antenna, a location and an orientation of the antenna changes, and an amount of control at initial capture of the communication target changes.

The antenna device generally has an azimuth axis and an elevation axis. The azimuth axis is an axis of rotation that changes an azimuth angle of an orientation direction that is a direction in which the antenna directs. The elevation axis is an axis of rotation that changes an elevation angle. The antenna device may further have an auxiliary axis that is an axis of rotation perpendicular to the elevation axis and capable of changing the orientation direction. These axes each generally have a predetermined mechanical drive range, and among the axes, the auxiliary axis may have a particularly narrow drive range. In the cooperative control of the antenna device having the auxiliary axis in the mobile communications, rotation around each axis is driven in the cooperative control to have an angle so that an amount of change of each axis from the original point of the coordinate system is minimized. Thus, at the initial capture of the communication target, the auxiliary axis may have an initial position shifted from the original point. In the subsequent control to track the communication target in such a state, the angle of rotation around the auxiliary axis may reach a limit of its drive range due to the initial position shifted from the original point of the auxiliary axis, which may cause a problem in that insufficient assist by the auxiliary axis for the azimuth axis and the elevation axis may result in failure to track the communication target.

In consideration of the aforementioned circumstances, an objective of the present disclosure is to provide an antenna device, an antenna control device, and a method for controlling the antenna device that can prevent an inability to track the communication target.

### Solution to Problem

To achieve the above objective, an antenna device according to the present disclosure includes an antenna, an azimuth support, an elevation support, an auxiliary support, and a control device. The antenna transmits electromagnetic waves to a communication target and receives electromagnetic waves from the communication target. The azimuth support supports the antenna rotatably around the azimuth axis. The elevation support supports the antenna rotatably around an elevation axis within a predetermined elevation axis rotation range. The auxiliary support supports the antenna rotatably around an auxiliary axis within a predetermined auxiliary axis rotation range that is narrower than the elevation axis rotation range. The auxiliary axis is perpendicular to the elevation axis. The control device includes a command orientation direction calculator, an original point setter, and a drive command value calculator. The command orientation direction calculator calculates a command orientation direction that is a direction for the antenna instructed to be oriented, and is a direction in which the communication target exists. At initial capture of the communication target, the original point setter sets an original point of an auxiliary axis to a midpoint of the auxiliary axis rotation range, and sets an original point of an azimuth axis and an original point of an elevation axis to an angle of the azimuth axis and an angle of the elevation axis, respectively, at which angles the antenna directs in the command orientation direction at the initial capture. The drive command value calculator calculates a drive command value indicating amounts by which the azimuth support, the elevation support, and the auxiliary support are driven so that (i) the antenna directs in the command orientation direction and (ii) a sum of amounts of change of the azimuth axis, the elevation axis, and the auxiliary axis from the respective original points is minimized.

### Advantageous Effects of Invention

The present disclosure provides an antenna device, an antenna control device, and a method for controlling the antenna device that can prevent an inability to track the communication target.

### BRIEF DESCRIPTION OF DRAWINGS

FIG. 1 is a diagram illustrating a schematic of a mobile communication system including an antenna device according to an embodiment of the present disclosure;

FIG. 2 is a block diagram illustrating a configuration of a mobile station equipped with the antenna device according to the embodiment;

FIG. 3 is a front view illustrating a structure of the antenna device according to the embodiment;

FIG. 4 is a side view illustrating the structure of the antenna device according to the embodiment;

FIG. 5 is a schematic view illustrating a relationship among a base support, an azimuth support, an auxiliary support, an elevation support, and a main reflector for change of an orientation direction of the antenna device according to the embodiment;

FIG. 6 is a schematic diagram illustrating a relationship among rotation axes when the orientation direction of the antenna device according to the embodiment is changed;

FIG. 7 is a flowchart illustrating a control process of the antenna device according to the embodiment;

FIG. 8 is a diagram illustrating sending and receiving of information in the antenna device according to the embodiment;

FIG. 9 is a diagram illustrating a sequence of initial capture and tracking of a communication target by the antenna device according to the embodiment;

FIG. 10 is a diagram illustrating a conventional method for generating a drive command value;

FIG. 11 is a diagram illustrating a method for generating a drive command value in the antenna device according to the embodiment;

FIG. 12 is a diagram illustrating a direction in which the communication target exists and a direction in which an AZ axis lies before capture of the communication target by the antenna device according to the embodiment; and

FIG. 13 is a diagram illustrating the direction in which the communication target exists and a direction in which the AZ axis lies after the capture of the communication target by the antenna device according to the embodiment.

### DESCRIPTION OF EMBODIMENTS

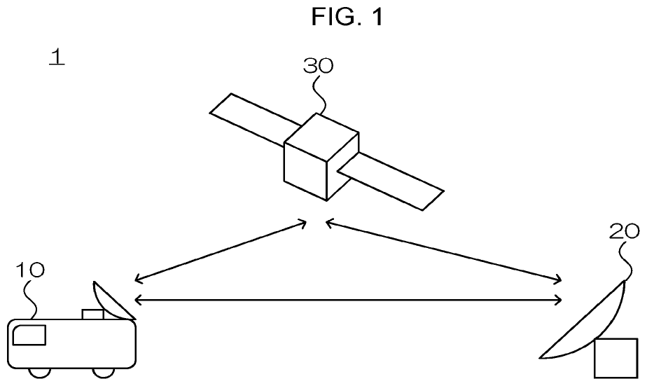

An antenna device according to an embodiment of the present disclosure is described with reference to FIGS. 1 to 13.

FIG. 1 is a diagram illustrating a schematic of a mobile communication system 1 including an antenna device according to an embodiment of the present disclosure. As illustrated in FIG. 1, the mobile communication system 1 includes a mobile station 10 that is a mobile communication station, a communication counterpart station 20 that is a terrestrial communication station that communicates with the mobile station 10, a relay station 30 that relays communication between the mobile station 10 and the communication counterpart station 20. Arrows illustrated in FIG. 1 indicate radio communication.

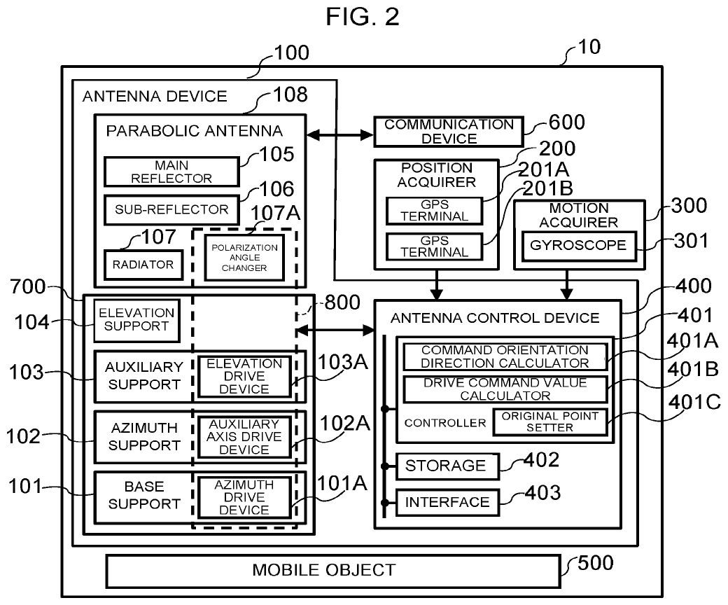

FIG. 2 is a block diagram illustrating a configuration of the mobile station 10 equipped with the antenna device according to the embodiment. As illustrated in FIG. 2, the mobile station 10 includes an antenna device 100 that emits and receives electromagnetic waves for communication, a communication device 600 for radio communication using the antenna device 100, a position acquirer 200 that calculates a position and a heading of the mobile station 10, a motion acquirer 300 that calculates a tilt (attitude) of the mobile station 10, and a mobile object 500 on which these components are mounted. The mobile station 10 is a mobile communication station that communicates directly with the communication counterpart station 20 or communicates via the relay station 30 with the communication counterpart 20. The communication target of the mobile station 10 is the relay station 30 in relay communication, and is the communication counterpart station 20 in non-relay communication.

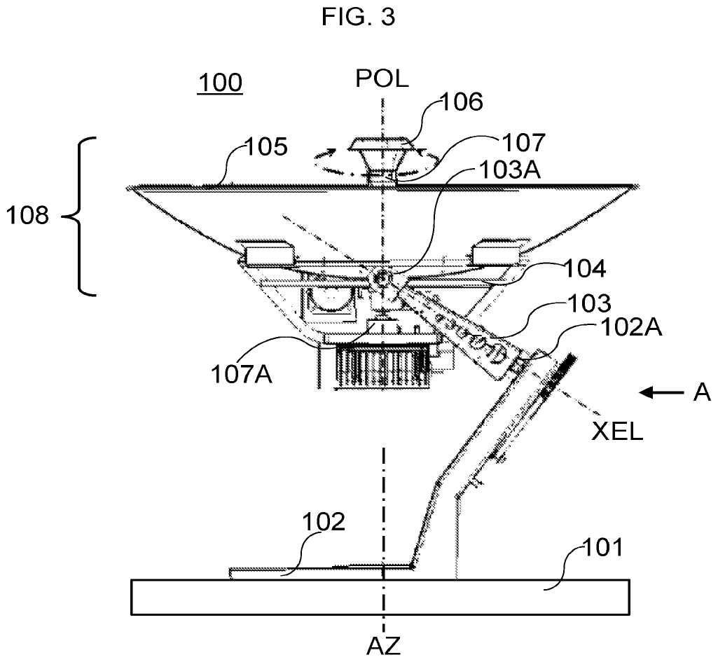

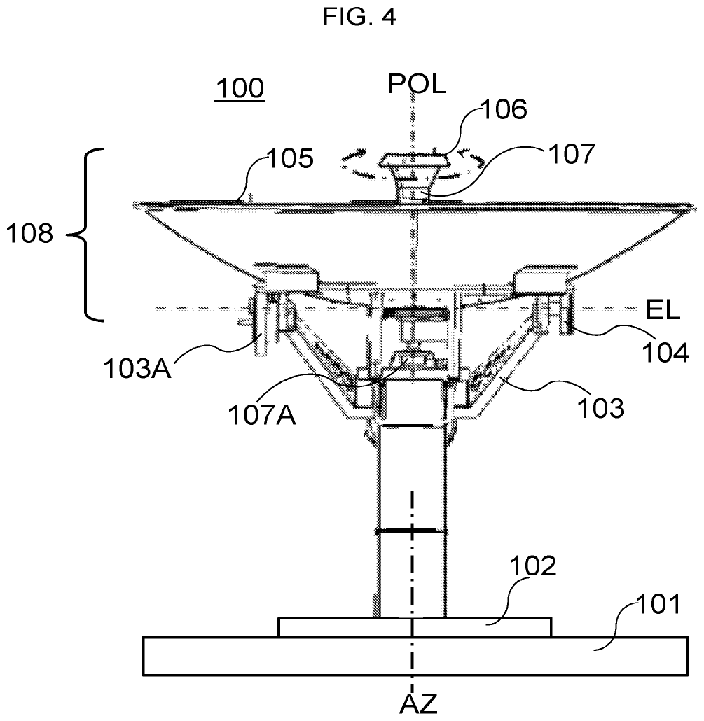

The antenna device 100 and the communication device 600 are mounted on the mobile object 500, and establish radio communication with the communication counterpart station 20 or the relay station 30 to and from which the antenna device 100 transmits and receives electromagnetic waves. FIG. 3 is a front view illustrating a structure of the antenna device 100, and FIG. 4 is a side view of the antenna device 100 as viewed in a direction indicated by an arrow A shown in FIG. 3.

The antenna device 100 includes a parabolic antenna 108, an antenna pedestal 700 that supports the parabolic antenna 108 such that an orientation direction of the parabolic antenna 108 can be changed, and an antenna control device 400 that controls a drive included in the antenna pedestal 700. The antenna pedestal 700 includes a base support 101 mounted on the mobile object 500, an azimuth support 102 supported by the base support 101, an auxiliary support 103 supported by the azimuth support 102, and an elevation support 104 supported by the auxiliary support 103. The elevation support 104 supports the parabolic antenna 108. The antenna control device 400 may not be included in the antenna device 100, but even in such a case, a device controlling the antenna device 100 can be considered to be the antenna control device 400.

An antenna drive device 800 is a drive that changes the orientation direction of the antenna pedestal 700. The antenna drive device 800 includes an azimuth drive device 101A that drives rotatably the azimuth support 102 relative to the base support 101, an auxiliary axis drive device 102A that drives rotatably the auxiliary support 103 relative to the azimuth support 102, and an elevation drive device 103A that drives rotatably the elevation support 104 relative to the auxiliary support 103.

The parabolic antenna 108 supported by the elevation support 104 includes a main reflector 105 that reflects electromagnetic waves that the parabolic antenna 108 receives and transmits, a subreflector 106 disposed at a focal point of the main reflector 105, and a waveguide radiator 107 that is disposed along an optical axis (POL axis) of the main reflector 105 and that transmits the electromagnetic waves toward the subreflector 106 and receives the electromagnetic waves coming from the subreflector 106. The radiator 107 is rotatable around the POL axis by the polarization angle changer 107A. The polarization angle changer 107A is included in the antenna drive device 800.

The communication device 600 includes an amplifier that amplifies power of the electromagnetic wave that the communication device 600 receives and transmits, a frequency converter that converts a frequency of the electromagnetic wave that the communication device 600 receives and transmits, and other devices commonly used in the radio communication. Detailed description of the communication device 600 is omitted since the communication device 600 is less related to the present disclosure.

The antenna device 100 is disposed on a reference surface of the mobile object 500 (illustrated in FIG. 2) via the base support 101. The base support 101 includes the azimuth drive device 101A that rotates the azimuth support 102 around an AZ axis (azimuth axis). The AZ axis and other rotation axes are described later in detail.

The azimuth support 102 is disposed on the base support 101 so as to be rotatable around the AZ axis. The AZ axis is an axis of rotation perpendicular to the reference surface of the mobile object 500. The azimuth support 102 includes a plate-like portion mounted on the base support 101 and an axis (XEL axis) that extends obliquely upward. The azimuth support 102 is provided with the auxiliary axis drive device 102A that rotates the auxiliary support 103 around the XEL axis (auxiliary axis).

The auxiliary support 103 is disposed on the azimuth support 102 on an upper end side of the azimuth support 102 so as to be rotatable around the XEL axis. The XEL axis intersects the AZ axis. The auxiliary support 103 has a predetermined drive range (rotatable angle range), and does not rotate beyond the range. The auxiliary support 103 includes a horizontal central portion and end portions located at both ends of the central portion. The end portions are bent relative to the central portion and extend obliquely upward. The central portion is connected to the azimuth support 102 so as to be rotatable around the XEL axis. The elevation support 104 is disposed on EL-axis-direction outer sides of the two end portions of the auxiliary support 103. The two end portions of the auxiliary support 103 rotatably support the elevation support 104 via an EL axis. The auxiliary support 103 is provided with the elevation drive device 103A that rotates the elevation support 104 around the EL axis (elevation axis).

The elevation support 104 is disposed on the auxiliary support 103 so as to be rotatable around the EL axis. When the angle of rotation around the XEL axis is zero degrees, the EL axis is parallel to the reference surface of the mobile object 500 and is orthogonal to the AZ axis. The EL axis is an axis of rotation crossing the AZ axis and perpendicular to the XEL axis. The AZ axis, the XEL axis, and the EL axis intersect at a single point.

The polarization angle changer 107A rotates the radiator 107 around the POL axis (polarization axis). The polarization angle changer 107A may also rotate the entire of the parabolic antenna 108 around the POL axis in addition to the radiator 107. The POL axis is an axis of rotation that is perpendicular to the EL axis and coincides with the optical axis of the main reflector 105. A drive for the POL axis is disposed on a rear side of the main reflector 106.

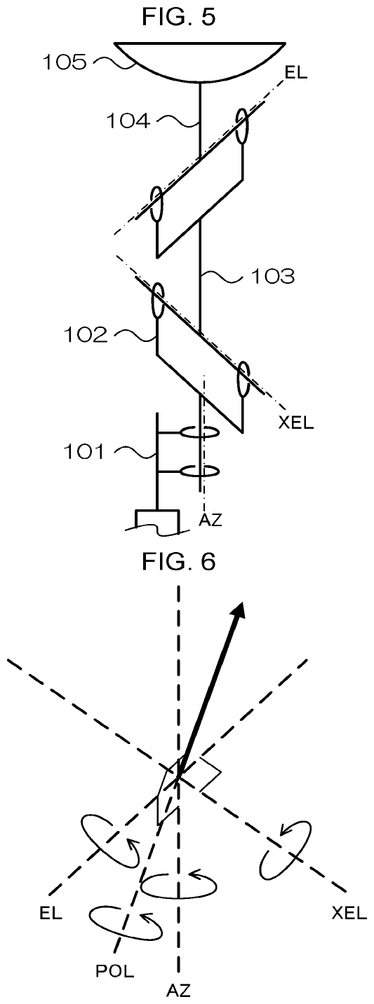

FIG. 5 is a schematic view illustrating a relationship among the base support 101, the azimuth support 102, the auxiliary support 103, the elevation support 104, and the main reflector 105, for change of the orientation direction of the antenna device according to the embodiment. FIG. 5 schematically illustrates each support with the rotation axis and bearings. As illustrated in FIG. 5, the azimuth support 102 is supported by the base support 101 so as to be rotatable around the AZ axis. The auxiliary support 103 is supported by the azimuth support 102 so as to be rotatable around the XEL axis. The elevation support 104 is supported by the auxiliary support 103 so as to be rotatable around the EL axis. The main reflector 105 is supported by the elevation support 104. In some antenna devices, the auxiliary support may be supported by the elevation support, and the polarization angle changer may be supported by the auxiliary support.

Referring back to FIGS. 3 and 4, the structure of the parabolic antenna 108 is described. The main reflector 105 has a reflection surface having, for example, a paraboloidal shape. The main reflector 105 reflects electromagnetic waves emitted by the radiator 107 and then reflected by the subreflector 106 or reflects incident electromagnetic waves transmitted by the communication counterpart station 20 or the relay station 30. The main reflector 105 is supported by the elevation support 104.

The radiator 107 is disposed rotatably around the POL axis so that the optical axis of the main reflector 105 coincides with the POL axis. The radiator 107 is a horn antenna, but is not limited thereto. The parabolic antenna 108 that is an antenna includes the main reflector 105, the subreflector 106, and the radiator 107. The parabolic antenna 108 transmits the electromagnetic waves to the communication target and receives the electromagnetic waves from the communication target. An antenna with the radiator disposed at the focal point of the main reflector 105 may be used.

The base support 101, the azimuth support 102, the auxiliary support 103, and the elevation support 104 support the parabolic antenna 108 that is a support target.

Rotation around the rotation axes driven by the antenna device 100 are described in more detail. FIG. 6 is a schematic diagram illustrating a relationship among the rotation axes when the orientation direction of the antenna device 100 is changed. The direction indicated by a bold arrow in FIG. 6 is a direction in which the parabolic antenna 108 directs.

As illustrated in FIG. 6, the AZ axis is a drive axis that drives the parabolic antenna 108 in a direction in which an azimuth angle of the parabolic antenna 108 changes. The AZ axis is also referred to as an azimuth axis.

The EL axis is a drive axis that drives the parabolic antenna 108 in a direction in which an elevation angle of the parabolic antenna 108 changes. The EL axis is perpendicular to the AZ axis when the angle of rotation around the XEL axis is zero degrees. The EL axis is also referred to as an elevation axis.

The POL axis is a drive axis that drives rotation of a polarization angle. The polarization angle indicates a direction of polarization of the electromagnetic waves to be transmitted. In a case of the parabolic antenna 108, the radiator 107 is rotated to cause rotation around the POL axis. The POL axis is perpendicular to the EL axis and coincides with the orientation direction of the parabolic antenna 108. The polarization direction of the electromagnetic waves to be transmitted is controlled by driving of the radiator 107 around the POL axis. The POL axis is also referred to as a polarization axis.

The XEL axis is an auxiliary drive axis that assists driving around the AZ axis and the EL axis. The XEL axis is perpendicular to the EL axis. The XEL axis is also referred to as an auxiliary axis. A predetermined rotatable angle range of rotation around the XEL axis is also referred to as an auxiliary axis rotation range. A predetermined rotatable angle range of rotation around the EL axis is also referred to as an elevation rotation range. The auxiliary axis rotation range is predetermined to be narrower than the elevation rotation range.

The AZ axis, the EL axis, the POL axis, and the XEL axis have their own angles from respective original points. The original points are generally defined in accordance with the structure. When the rotatable angle of the rotation axis falls within 360°, the original point is preferably set so that the rotatable angles in positive and negative directions have the same size. Here, the rotatable angle range of each axis is as follows. The AZ axis can have a full azimuth angle coverage, and there is no limit to the rotation angle range. The EL axis can vary in a range of angles between 0° and 180°. The XEL axis can vary, for example, in a range of angle between +20° and −20°. The POL axis can take any angle of 360°, and there is no limit to the rotation angle range.

Referring back to FIG. 2, the configuration of the mobile station 10 is described. The position acquirer 200 includes at least two global positioning system (GPS) terminals 201A and 201B. The GPS terminals 201A and 201B are collectively referred to as a GPS terminal 201. The position acquirer 200 calculates a position of the mobile object 500 from positions acquired by the GPS terminal 201. The position acquirer 200 also calculates, based on a relative relationship between the GPS terminals 201A and 201B, a heading that is a direction in which the front (nose) of the mobile object 500 directs. The position acquirer 200 sends the calculated position and heading of the mobile object 500 to the antenna control device 400. The position acquirer 200 is mounted on the mobile object 500.

The motion acquirer 300 includes a three-axis gyroscope 301. The gyroscope 301 measures angles and angular velocities of rotation around three axes that are pitch, yaw, and roll axes. The motion acquirer 300 calculates, as a motion estimation, tilts of the mobile object 500 around the three axes based on the angles of rotation and the angular velocities measured by the gyroscope 301. The motion acquirer 300 sends to the antenna control device 400 the motion estimation calculated based on the angles of rotation around the three axes of pitch, yaw, and roll. The motion acquirer 300 is mounted on the mobile object 500. The motion acquirer 300 may be included in the antenna device 100. In some cases, the tilts around the three axes of the mobile object 500 is estimated without considering the angular velocity.

The antenna control device 400 controls the antenna drive device 800 in a cooperative manner to capture and track the communication counterpart station 20 or the relay station 30 that is a communication target. The antenna control device 400 includes a controller 401, a storage 402 that stores data and a program, and an interface 403 through which input from a user is received and information is presented to the user. The controller 401 controls the antenna drive device 800 by calculating a parameter for control of the antenna drive device 800. The antenna control device 400 is mounted on the mobile object 500.

The controller 401 is a processor. The controller 401 includes a command orientation direction calculator 401A, a drive command value calculator 401B, and an original point setter 401C. The command orientation direction calculator 401A calculates a command orientation direction that is a direction in which the parabolic antenna 108 is instructed to be oriented. The drive command value calculator 401B calculates a drive command value indicating amounts by which the azimuth support 102, the auxiliary support 103, the elevation support 104, and the polarization angle changer 107A are driven so that the parabolic antenna 108 directs in the command orientation direction. The antenna drive device 800 controls and drives the azimuth support 102, the auxiliary support 103, the elevation support 104, and the polarization angle changer 107A, based on the drive command value. The controller 401 includes a central processing unit (CPU), but is not limited thereto. The antenna control device 400 is a control device that drives the azimuth support 102, the auxiliary support 103, the elevation support 104, and the polarization angle changer 107A.

The command orientation direction calculator 401A calculates the command orientation direction based on the position of the mobile object 500 acquired by the position acquirer 200 and a position, received from the outside, of the communication counterpart station 20 or the relay station 30 that is the communication target. The command orientation direction is a direction for the parabolic antenna 108 instructed to be oriented, and is a direction in which the communication target exists.

The original point setter 401C performs replacement of original orientation for each axis of the AZ axis, the EL axis, the POL axis, and the XEL axis in the initial capture of the communication target. The initial capture is performed before communication with the communication target is started or when tracking of the communication target is disabled. Specifically, the controller 401 resets original points of AZ-axis, EL-axis, and POL-axis to the angles of rotation around the AZ axis, the EL axis, and the POL axis at which the parabolic antenna 108 directs to the communication target at the initial capture, respectively. That is, the controller 401 replaces original points of the AZ-axis, EL-axis, and POL-axis that are the original points in the coordinate system specific to the antenna device with the angles of the AZ axis, the EL axis, and the POL axis at which the parabolic antenna 108 directs to the command orientation direction at the initial capture. The original point of XEL-axis is not changed because the angle of rotation around the XEL axis is zero degrees in the command orientation direction at the initial capture. The midpoint of the movable range (auxiliary axis rotation range) of the XEL axis is defined to be zero degrees. The original points of AZ-axis, EL-axis, and POL-axis may differ from the angles of the AZ axis, the EL axis, and the POL axis at which the antenna directs to the communication target as long as the difference falls within a permissible range. In addition, the original point of XEL-axis may be an angle other than zero degrees as long as a difference between the angle and zero degrees is significantly small.

The drive command value calculator 401B calculates a drive command value indicating amounts by which the azimuth support 102, the auxiliary support 103, the elevation support 104, and the radiator 107 are driven so that the parabolic antenna 108 directs in the command orientation direction, based on the command orientation direction calculated at the initial capture, the heading of the mobile object 500 acquired by the position acquirer 200, the tilts of the mobile object 500 acquired by the motion acquirer 300, and the angles of the azimuth support 102, the auxiliary support 103, the elevation support 104, and the radiator 107.

The controller 401 drives the azimuth support 102, the elevation support 104, and the radiator 107 based on the calculated drive command value to cause the parabolic antenna 108 to direct to the communication target.

The storage 402 stores positional information of the communication counterpart station 20 or the relay station 30 that is the communication target, a program for the controller 401 to calculate the drive command value, and a program for the controller 401 to calculate the drive command value for driving of the azimuth support 102, the auxiliary support 103, the elevation support 104, and the radiator 107. The storage 402 includes a read only memory (ROM) and a random access memory (RAM), but is not limited thereto.

The interface 403 receives input from a user and presents information to the user. Examples of the input from the user include designation of the communication target, a user instruction to start and end a control process, and an instruction about a signal for transmission. The interface 403 sends the received instruction to the controller 401 and presents to the user the information received from the controller 401. Examples of the interface 403 include (i) a button, a key, and a touchpad for receiving input from a user, (ii) a liquid crystal display and a speaker for presenting information to the user, and (iii) a touch panel for both of input and output. The interface 403 may be one or more of these examples, but is not limited thereto.

The mobile object 500 is an object on which the antenna device 100, the position acquirer 200, and a motion acquirer 300 are mounted. The mobile object 500 is, for example, an automobile.

Referring back to FIG. 1, the configuration of the mobile communication system 1 is described. The communication counterpart station 20 is a terrestrial communication station that communicates directly with the mobile station 10 or communicates with the mobile station 10 via the relay station 30.

The relay station 30 is a station, for example a communication satellite, that relays communication between the mobile station 10 and the communication counterpart station 20.

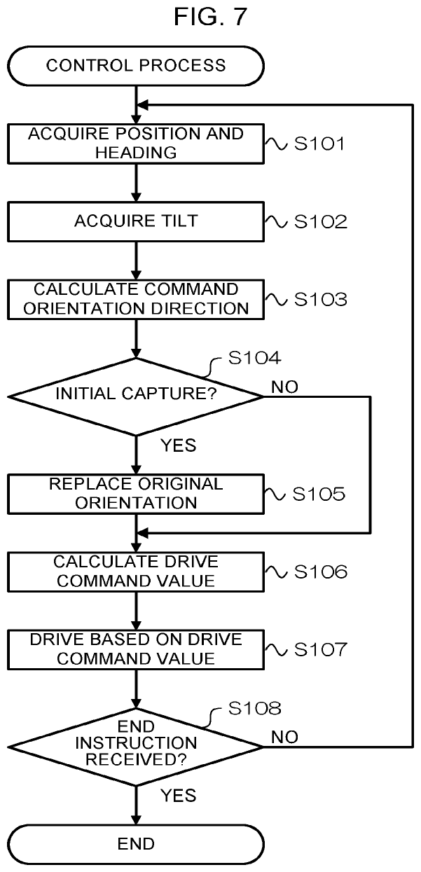

FIG. 7 is a flowchart illustrating a control process executed by the antenna control device 400. Capture processing for the antenna control device 400 to control the antenna drive device 800 to capture initially the communication target is described with reference to the flowchart shown in FIG. 7. The mobile station 10 is assumed here to communicate with the communication counterpart station 20 via the relay station 30. The relay station 30 is, for example, a communication satellite. That is, the antenna control device 400 controls the antenna drive device 800 to cause the parabolic antenna 108 to capture the relay station 30.

Upon start of the control process, the antenna control device 400 acquires a position and a heading of the mobile object 500 calculated by the position acquirer 200 (Step S101).

Upon acquisition of the position and the heading of the mobile object 500, the antenna control device 400 acquires tilts of the mobile object 500 calculated by the motion acquirer 300 (Step S102).

Upon acquisition of the tilts of the mobile object 500, the antenna control device 400 calculates a command orientation direction based on the acquired position of the mobile object 500 and the position of the relay station 30 that is the communication target (Step S103).

Upon calculation of the command orientation direction, the antenna control device 400 checks whether this capture is the initial capture (Step S104). When the capture is the initial capture (YES in Step S104), the antenna control device 400 performs replacement of the original orientation (Step S105).

After replacement of the original orientation or when the capture is not the initial capture (NO in Step S104), the antenna control device 400 calculates a drive command value for driving of the azimuth support 102, the auxiliary support 103, the elevation support 104, and the radiator 107 based on the calculated command orientation direction, the acquired heading and tilts of the mobile object 500, and the angles of the azimuth support 102, the auxiliary support 103, the elevation support 104, and the radiator 107 (Step S106).

Upon calculation of the drive command value, the antenna drive device 800 drives the azimuth support 102, the auxiliary support 103, the elevation support 104, and the radiator 107 based on the calculated drive command value (Step S107).

During the driving based on the drive command value, the antenna control device 400 periodically checks whether the interface 403 receives an instruction to end the control process (Step S108). When the interface 403 receives the instruction (YES in Step S108), the antenna control device 400 ends the control process. When the antenna control device 400 determines that the interface 403 does not receive the instruction (NO in Step S108), the control process returns to Step S101. Steps S101 to S108 are periodically repeated.

Through the above control process, the antenna device according to the present embodiment performs replacement of the original orientation in the initial capture processing, thereby preventing the angle of rotation around the XEL axis, which is the auxiliary axis, from being shifted from zero degrees (the midpoint of the movable range) at the initial capture.

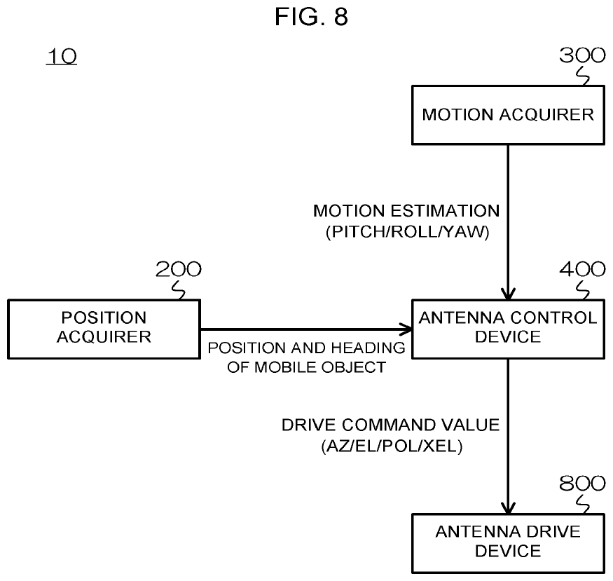

FIG. 8 is a drawing illustrating sending and receiving of information in the antenna device 100. As illustrated in FIG. 8, the position acquirer 200 calculates the position and the heading of the mobile object 500 and sends the calculated position and heading to the antenna control device 400. The motion acquirer 300 calculates, as a motion estimation, angles of rotation of the mobile object 500 around the three axes that are pitch, yaw, and roll axes, and sends the motion estimation to the antenna control device 400.

The antenna control device 400 calculates, based on the position and the heading of the mobile object 500 and the position of the communication target, a drive command value indicating amounts by which rotations around the AZ axis, the EL axis, the POL axis, and the XEL axis are driven, and sends the calculated the drive command value to the antenna drive device 800. The antenna drive device 800 drives the AZ axis, the EL axis, the POL axis, and the XEL axis based on the received drive command value.

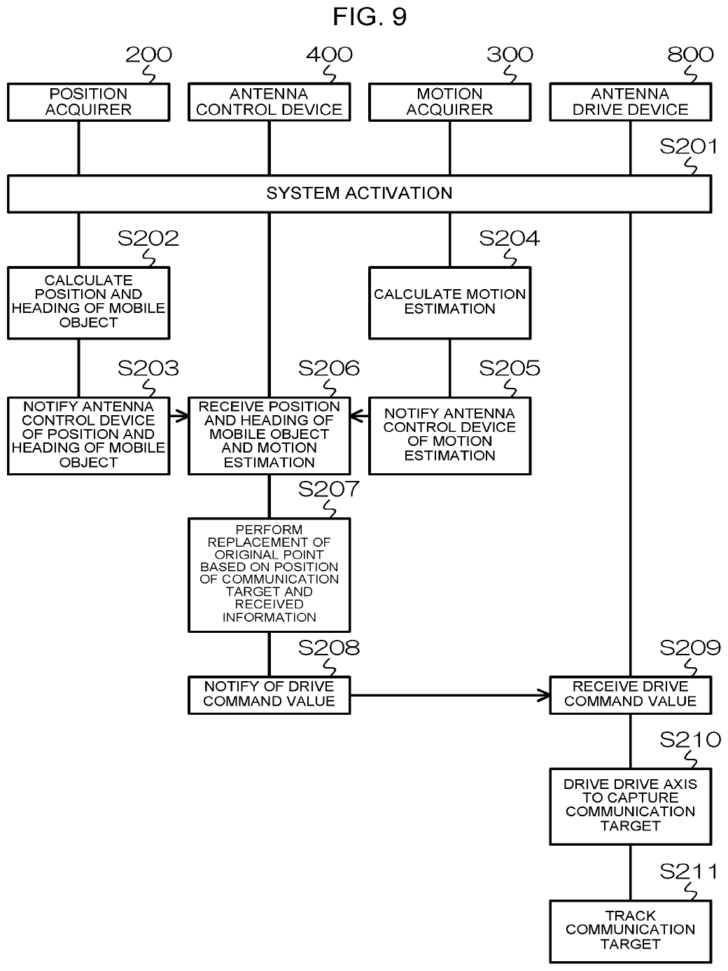

FIG. 9 is a diagram illustrating a sequence of initial capture and tracking of the communication target by the antenna device 100. Operations of the position acquirer 200, the motion acquirer 300, the antenna control device 400, and the antenna drive device 800 are described individually with reference to FIG. 9.

First, a system including the antenna device 100 (including the antenna control device 400 and the antenna drive device 800), the position acquirer 200, and the motion acquirer 300 is activated (Step S201).

Upon activation of the system, the position acquirer 200 calculates the position and the heading of the mobile object 500 (Step S202), and sends the calculated position and heading of the mobile object 500 to the antenna control device 400 (Step S203).

In parallel to Steps S202 and S203, the motion acquirer 300 calculates, as a motion estimation, the angles of rotation of the mobile object 500 around the three axes that are pitch, yaw, and roll axes (Step S204), and sends the motion estimation to the antenna control device 400 (Step S205).

After the position and the heading of the mobile object 500 and the motion estimation are provided, the antenna control device 400 receives the position and the heading of the mobile object 500 and the motion estimation (Step S206).

After receiving the position and the heading of the mobile object 500 and the motion estimation, the antenna control device 400 performs replacement of the original point based on the received position and heading of the mobile object 500, the received motion estimation, and the position of the communication target, and generates a drive command value (Step S207). The antenna control device 400 then notifies the antenna drive device 800 of the generated drive command value (Step S208). Generation of the drive command value is described later in detail.

Upon notification of the drive command value, the antenna drive device 800 receives the drive command value (Step S209).

Upon reception of the drive command value, the antenna drive device 800 drives, based on the received drive command value, the AZ axis, the EL axis, the POL axis, and the XEL axis that are the drive axes, and captures the communication target (Step S210). Following the capture of the communication target, the antenna drive device 800 tracks the communication target (Step S211). During the tracking of the communication target, Steps S202 to S210 except for the replacement of the original point in Step S207 are repeated in a predetermined cycle.

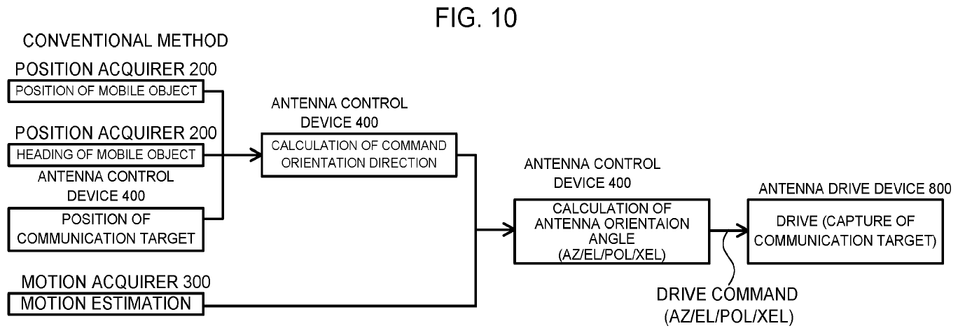

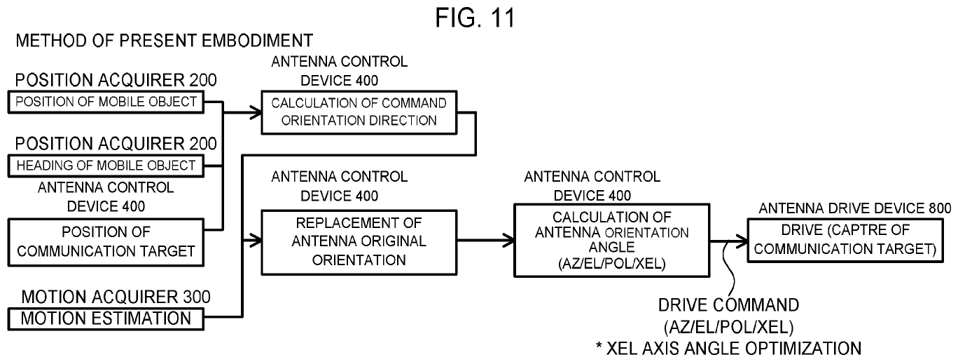

Generation of the drive command value (Step S207) in FIG. 9 and the associated operations are described with reference to FIGS. 10 and 11. FIG. 10 is a diagram illustrating a conventional method for generating a drive command value, and FIG. 11 is a diagram illustrating a method for generating a drive command value according to the present embodiment. Descriptions above boxes illustrated in each of FIGS. 10 and 11 indicate names of components of the mobile station 10, and descriptions inside the boxes indicate information held by the components or operations executed by the components. For ease of understanding, the components of the present embodiments are also used for description of the conventional method.

First, the conventional method is described. As illustrated in FIG. 10, the antenna control device 400 calculates a command orientation direction based on a position of the communication target that is information held by the antenna control device 400 and a position and a heading of the mobile object 500 calculated by the position acquirer 200.

Upon calculation of the command orientation direction, the antenna control device 400 calculates an antenna orientation angle that is an angle of rotation around the AZ axis, the EL axis, the POL axis, and the XEL axis for directing the parabolic antenna 108 in the command orientation direction. The antenna control device 400 also calculates a drive command value for the AZ axis, the EL axis, the POL axis, and the XEL axis to achieve the antenna orientation angle, and sends the calculated drive command value to the antenna drive device 800. At this time, the original orientation of the antenna is device-specific original orientation.

After receiving the drive command value, the antenna drive device 800 drives the AZ axis, the EL axis, the POL axis, and the XEL axis based on the received drive command value, and captures the communication target.

In contrast, as illustrated in FIG. 11, the antenna device 400 according to the present embodiment replaces the original orientation of the antenna with the command orientation direction calculated at the initial capture and then calculates the antenna orientation angle defined by angles of the AZ axis, the EL axis, the POL axis, and the XEL axis for directing the parabolic antenna 108 in the command orientation direction. The antenna control device 400 also calculates a drive command value for the AZ axis, the EL axis, the POL axis, and the XEL axis to achieve the antenna orientation angle, and sends the calculated drive command value to the antenna drive device 800. Such replacement of the original orientation of the antenna before calculation of the antenna orientation angle and the drive command value sets an angle of rotation around the XEL axis not to be shifted from zero degree at the initial capture and optimizes the angle of rotation around the XEL axis.

With the above method, the antenna device according to the present embodiment can prevent rotation around the XEL axis, which is the auxiliary axis, from being shifted from zero degrees at the initial capture by replacement of the original orientation at the initial capture.

Next, reasons that the angle of rotation around the XEL axis cannot have an angle of the optimum value (zero degrees) with the conventional method are described. In a case where the support structure of the antenna device 100 has an AZ-XEL-EL-POL axial configuration that supports the axes in an order of the AZ axis, the XEL axis, the EL axis, and the POL axis, an orientation transformation matrix T for directing the antenna in a direction (φAZ, φEL, φPOL, φXEL) is given as follows.

$$\begin{matrix}T = & R ( ϕ AZ ) R ( ϕ XEL ) R ( ϕ EL ) R ( ϕ POL ) \\ = & ( \begin{matrix}cos ϕ AZ & - sin ϕ AZ & 0 \\ sin ϕ AZ & cos ϕ AZ & 0 \\ 0 & 0 & 1\end{matrix} ) ( \begin{matrix}cos ϕ XEL & 0 & - sin ϕ XEL \\ 0 & 1 & 0 \\ sin ϕ XEL & 0 & cos ϕ XEL\end{matrix} ) \\ & ( \begin{matrix}1 & 0 & 0 \\ 0 & cos ϕ EL & - sin ϕ EL \\ 0 & sin ϕ EL & cos ϕ EL\end{matrix} ) \\ & ( \begin{matrix}cos ϕ POL & 0 & - sin ϕ POL \\ 0 & 1 & 0 \\ sin ϕ POL & 0 & cos ϕ POL\end{matrix} )\end{matrix} \qquad [ Eq . 1 ]$$

In a case where the support structure of the antenna device 100 has an AZ-EL-XEL-POL axial configuration that supports the axes in an order of the AZ axis, the EL axis, the XEL axis, and the POL axis, an orientation transformation matrix T for directing the antenna in a direction (φAZ, φEL, φPOL, φXEL) is given as follows.

$$\begin{matrix}T = & R ( ϕ AZ ) R ( ϕ EL ) R ( ϕ XEL ) R ( ϕ POL ) \\ = & ( \begin{matrix}cos ϕ AZ & - sin ϕ AZ & 0 \\ sin ϕ AZ & cos ϕ AZ & 0 \\ 0 & 0 & 1\end{matrix} ) ( \begin{matrix}1 & 0 & 0 \\ 0 & cos ϕ EL & - sin ϕ EL \\ 0 & sin ϕ EL & cos ϕ EL\end{matrix} ) \\ & ( \begin{matrix}cos ϕ XEL & 0 & - sin ϕ XEL \\ 0 & 1 & 0 \\ sin ϕ XEL & 0 & cos ϕ XEL\end{matrix} ) \\ & ( \begin{matrix}cos ϕ POL & 0 & - sin ϕ POL \\ 0 & 1 & 0 \\ sin ϕ POL & 0 & cos ϕ POL\end{matrix} )\end{matrix} \qquad [ Eq . 2 ]$$

In a case of an AZ-EL-POL axial configuration, an orientation transformation matrix T for directing the antenna in a direction (φAZ, φEL, φPOL) is given as follows.

$$\begin{matrix}T = & R ( ϕ AZ ) R ( ϕ EL ) R ( ϕ POL ) \\ = & ( \begin{matrix}cos ϕ AZ & - sin ϕ AZ & 0 \\ sin ϕ AZ & cos ϕ AZ & 0 \\ 0 & 0 & 1\end{matrix} ) ( \begin{matrix}1 & 0 & 0 \\ 0 & cos ϕ EL & - sin ϕ EL \\ 0 & sin ϕ EL & cos ϕ EL\end{matrix} ) \\ & ( \begin{matrix}cos ϕ POL & 0 & - sin ϕ POL \\ 0 & 1 & 0 \\ sin ϕ POL & 0 & cos ϕ POL\end{matrix} )\end{matrix} \qquad [ Eq . 3 ]$$

Although the detailed description is omitted, the following relationships are established between the angles (φAZ, φEL, φPOL, φXEL) of the axes for directing the antenna in the direction (φAZ0, φEL0, φPOL0) in the AZ-XEL-EL-POL axial configuration:

sin φEL=sin φEL0/cos φXEL (1)

φAZ=φAZ0−α (2)

φPOL=φPOL0−β (3)

where α and β satisfy the following:

sin α=tan φXEL*tan φEL0 (4)

sin β=sin φXEL/cos φEL0 (5)

According to the conventional method, the angle (φAZ, φEL, φPOL, φXEL) of rotation around each axis is determined such that the antenna is oriented in a direction (φAZ0, φEL0, φPOL0) and the objective function f shown below is minimized. The direction in which the antenna directs before the original point of the coordinate system of the antenna device is changed is taken to be (0, 0, 0, 0). The objective function f here is a function for minimizing the sum of squares of amounts of change from the original points of AZ-axis, XEL-axis, EL-axis, and POL-axis. Instead of the sum of squares function, any objective function f for example, the sum of the absolute value of the amounts of change from the original points of AZ-axis, XEL-axis, EL-axis, and POL-axis, may be used as long as the sum of the amounts of change from the original point can be minimized. Use of the sum of squares function enables easier analysis.

f=(φAZ)²+(φXEL)²+(φEL)²+(φPOL)² (6)

Equation (6) may be an equation for determining a weighted sum of squares that is a sum of squares multiplied by a weighting coefficient that corresponds to a cost estimated in a case in which the angle of rotation around each axis is changed by a unit angle.

Here, the angles (φAZ, φEL, φPOL, φXEL) with the minimized value of Equation (6) are evaluated, assuming that sin φXEL≈φXEL and cos φXEL≈1. Equations (1), (2), and (3) are given by

φEL≈φEL0 (1A)

φAZ≈φAZ0−φXEL*tan φEL0 (2A)

φPOL≈φPOL0−φXEL/cos φEL0 (3A)

Substituting Equations (1A), (2A), and (3A) into Equation (6) gives

$$\begin{matrix}f \approx & {( ϕ AZ 0 - ϕ XEL * tan ϕ EL 0 )}^{2} + ϕ {XEL}^{2} + ϕ EL {0}^{2} + \\ & {( ϕ POL 0 - ϕ XEL \text{/} cos ϕ EL 0 )}^{2} \\ = & ( 2 + {sin}^{2} ϕ EL 0 ) * {( ϕ XEL \text{/} cos ϕ EL 0 )}^{2} - \\ & ( 2 ϕ AZ 0 * sin ϕ EL 0 + ϕ POL 0 ) * \\ & ( ϕ XEL \text{/} cos ϕ EL 0 ) + ϕ AZ {0}^{2} + ϕ POL {0}^{2} \\ = & ( 2 + {sin}^{2} ϕ EL 0 ) * ( ϕ XEL \text{/} cos ϕ EL 0 - \\ & { ( ϕ AZ 0 * sin ϕ EL 0 + ϕ POL 0 ) \text{/} ( 2 + {sin}^{2} ϕ EL 0 ) )}^{2} + \\ & ϕ AZ {0}^{2} + ϕ POL {0}^{2} - ( ϕ AZ 0 * sin ϕ EL 0 + \\ & { ϕ POL 0 )}^{2} \text{/} ( 2 + {sin}^{2} ϕ EL 0 )\end{matrix} \qquad ( 6 A )$$

Equation (6A) indicates that the minimum value of the objection function f is obtained when φXEL satisfies the following equation.

φXEL=(φAZ0*sin φEL0+φPOL0)*cos φEL0/(2+sin²φEL0) (7)

Equation (7) indicates that when φAZ0+φPOL0/sin φEL0 is non-zero, then φXEL is non-zero.

For example, when the antenna is oriented in the direction (φAZ0, φEL0, φPOL0)=(175°, 42.7°, −75°), the angles become (φAZ, φEL, φPOL, φXEL)=(170°, 43.4°, −50.7°, 21.7°). This can also be confirmed by calculation of the objective function f by Equation (6).

The value of the objective function f for (φAZ, φEL, φPOL, φXEL)=(170°, 43.4°, −50.7°, 21.7°) is taken as f1. The value of the objective function f for (φAZ, φEL, φPOL, φXEL)=(175°, 42.7°, −75°, 0°) is taken to be f2. The values f1 and f2 are as follows:

f1=33824.94

f2=38073.29

This relationship f2>f1 shows that the objective function f does not have a minimum value when φXEL=0 is satisfied.

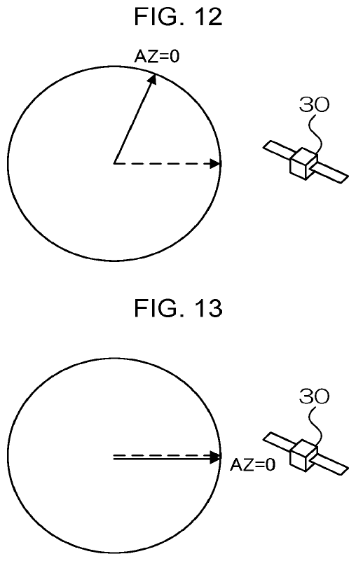

Advantages of the present embodiment are described with reference to the drawings. FIG. 12 is a diagram illustrating a direction in which the relay station 30 that is the communication target exists and a direction in which the AZ axis of the antenna device 100 lies before capture. FIG. 13 is a diagram illustrating the direction in which the relay station 30 that is the communication target exists and a direction in which the AZ axis of the antenna device 100 lies after the capture. The antenna device 100 starts performing capture processing in a state indicated in FIG. 12, which results in a state in which the antenna device 100 captures the relay station 30 as indicated in FIG. 13.

As illustrated in FIG. 12, the direction in which the communication target exists at the initial capture indicated by a dashed arrow is not generally matched with a device-specific original orientation of the AZ axis indicated by a solid arrow. When control is performed based on the drive command value calculated by the conventional cooperative control under such circumstances, the initial capture of the communication target may be completed with the angle of rotation around the XEL axis shifted from the original point (zero degrees). In the subsequent tracking of the communication target with the angle of rotation around the XEL axis shifted from the original point, the angle of rotation around the XEL axis may reach a limit (upper or lower limit) of its drive range due to the initial position shifted from the original point. The XEL axis cannot assist the AZ axis and the EL axis beyond the limit, which may result in inability to track the communication target. In particular, the XEL axis may be designed to have a small drive range since the XEL axis is a drive axis for assisting the AZ axis and the EL axis, and thus the XEL axis may quickly reach its limit of the drive range when the initial position of the XEL axis is shifted from the original point.

When control is performed based on the drive command value calculated after replacement of the original orientation performed at the initial capture in the capture processing according to the present embodiment, the capture of the communication target is completed with the initial angle of rotation around the XEL axis set to zero degrees. The subsequent tracking of the communication target is performed with the angle of rotation around the XEL axis not shifted from the original point (zero degrees) at the initial capture, thereby providing full use of the drive range of the XEL axis, which can prevent inability to track the communication target. In addition, the fact that the angle of rotation around the XEL axis is set at the initial capture to zero degrees that is the midpoint of the movable range can achieve efficient calculation processing for tracking, reduce time and amounts of drive necessary for operations for following the communication target, reduce energy necessary for operations, and increase the lifetime of the device.

Even in a case in which replacement of the original orientation is not performed, the angles of rotation around the AZ axis, the EL axis, the POL axis, and the XEL axis at the initial capture can be set to the same values that are set in a case in which replacement of the original orientation in the present embodiment is performed. To achieve this, it is sufficient to calculate the drive command value so that the angle of rotation around the XEL axis is set to zero degrees at the initial capture of the communication target from the initial state. With this approach, however, the angle of rotation around the XEL axis may have a value close to the original point of the coordinate system specific to the antenna device (or a value close to a boundary value of the movable range of rotation around the XEL axis) by cooperative control at the start of the tracking of the communication target, that is, at the second and subsequent capture of the communication target. The angle of rotation around the XEL axis may continue to be at the boundary value of the movable range in the subsequent tracking, and may not be able to take an angle calculated by cooperative control. This may cause the failure of tracking the communication target after the angle of rotation around the XEL axis reaches the boundary value of the movable range. In the present embodiment, the angle of rotation around the XEL axis is varied, at the second and subsequent capture of the communication target, relative to the original point set to the midpoint of the movable range, which can prevent the angle of rotation around the XEL axis from reaching the boundary value of the movable range in the subsequent tracking. In addition, there is no need to change computation logic for calculating the drive command value between the first capture and the second and subsequent capture of the communication target.

Embodiments of the present disclosure are not limited to the above embodiment, and changes may be made. For example, the automobile is described as an example of the mobile object 500, but the mobile object 500 is not limited thereto. Examples of the mobile object include various types of mobile objects such as a train, a ship, a fixed-wing aircraft, and a rotary-wing aircraft. The present disclosure may be applied to an antenna device for tracking the mobile object.

The antenna device 100 is described above as having the AZ axis, the EL axis, the POL axis, and the XEL axis, but is not limited to such a configuration. The antenna device may have a three-axis configuration without the POL axis. Alternatively, the antenna device may have a configuration of five or more axes including the XEL axis and an additional auxiliary axis.

The base support 101 is described above as including the drive device for rotating the azimuth support 102, but is not limited to such a configuration. The azimuth support 102 may include a drive device for rotating the azimuth support 102. The same applies to the azimuth support 102, the auxiliary support 103, and the elevation support 104.

In addition, the supports and the rotation axes can be combined in any combination. With any combination, the base support 101, the azimuth support 102, the auxiliary support 103, and the elevation support 104 support the parabolic antenna 108 that is a support target.

The antenna device 100 is described above as including the parabolic antenna 108 that includes the main reflector 105, the subreflector 106, and the radiator 107, but is not limited to such a configuration. The antenna may be an antenna not including a subreflector, and may be other types of antennas, for example, an antenna without a reflector such as an array antenna or a planar antenna.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2017-028034, filed on Feb. 17, 2017, the entire disclosure of which is incorporated by reference herein.

### INDUSTRIAL APPLICABILITY

The present disclosure is applicable to an antenna device, an antenna control device, and a method for controlling the antenna device.

### REFERENCE SIGNS LIST

1 Mobile communication system

10 Mobile station

20 Communication counterpart station

30 Relay station

100 Antenna device

101 Base support

101A Azimuth drive device

102 Azimuth support

102A Auxiliary axis drive device

103 Auxiliary support

103A Elevation drive device

104 Elevation support

105 Main reflector

106 Subreflector

107 Radiator

107A Polarization angle changer

108 Parabolic antenna

200 Position acquirer

201, 201A, 201B GPS terminal

300 Motion acquirer

301 Gyroscope

400 Antenna control device (control device)

401 Controller

401A Command orientation direction calculator

401B Drive command value calculator

401C Original point setter

402 Storage

403 Interface

500 Mobile object

600 Communication device

700 Antenna pedestal

800 Antenna drive device

1. An antenna device comprising:
an antenna to transmit an electromagnetic wave to a communication target and receive an electromagnetic wave from the communication target;
an azimuth support to support the antenna rotatably around an azimuth axis;
an elevation support to support the antenna rotatably around an elevation axis within an elevation axis rotation range, the elevation axis rotation range being predetermined;
an auxiliary support to support the antenna rotatably around an auxiliary axis within an auxiliary axis rotation range, the auxiliary axis rotation range being predetermined to be narrower than the elevation axis rotation range, the auxiliary axis being perpendicular to the elevation axis; and
a control device, the control device including
a command orientation direction calculator to calculate a command orientation direction, the command orientation direction being a direction for the antenna instructed to be oriented, and being a direction in which the communication target exists,
an original point setter to, at initial capture of the communication target, set an original point of an auxiliary axis to a midpoint of the auxiliary axis rotation range and set an original point of an azimuth axis and an original point of an elevation axis to an angle of rotation around the azimuth axis and an angle of rotation around the elevation axis, respectively, at which angles the antenna directs in the command orientation direction at the initial capture, and
a drive command value calculator to calculate a drive command value indicating amounts by which the azimuth support, the elevation support, and the auxiliary support are driven so that (i) the antenna directs in the command orientation direction and (ii) a sum of amounts of change of the azimuth axis, the elevation axis, and the auxiliary axis from the respective original points is minimized.

2. The antenna device according to claim 1, further comprising a base support connected to one end portion of the azimuth support and mounted on a mobile object.

3. The antenna device according to claim 1, further comprising a polarization angle changer to rotate the antenna or a radiator included in the antenna around a polarization axis that is perpendicular to the elevation axis and the auxiliary axis.

4. The antenna device according to claim 3, wherein
at the initial capture of the communication target, the original point setter sets an original point of a polarization axis to an angle of rotation around the polarization axis at which the antenna directs in the command orientation direction at the initial capture, and
the drive command value calculator calculates a drive command value indicating amounts by which the azimuth support, the elevation support, the auxiliary support, and the radiator are driven so that a sum of amounts of change of the azimuth axis, the elevation axis, the auxiliary axis, and the polarization axis from the respective original points is minimized.

5. An antenna control device for controlling an antenna device, the antenna device including an antenna to transmit an electromagnetic wave to a communication target and receive an electromagnetic wave from the communication target; an azimuth support to support the antenna rotatably around an azimuth axis; an elevation support to support the antenna rotatably around an elevation axis within an elevation axis rotation range, the elevation axis rotation range being predetermined; and an auxiliary support to support the antenna rotatably around an auxiliary axis within an auxiliary axis rotation range, the auxiliary axis rotation range being predetermined to be narrower than the elevation axis rotation range, the auxiliary axis being perpendicular to the elevation axis, the antenna control device comprising:
a command orientation direction calculator to calculate a command orientation direction being a direction for the antenna instructed to be oriented, and being a direction in which the communication target exists,
an original point setter to, at initial capture of the communication target, set an original point of an auxiliary axis to a midpoint of the auxiliary axis rotation range and set an original point of an azimuth axis and an original point of an elevation axis to an angle of rotation around the azimuth axis and an angle of rotation around the elevation axis, respectively, at which angles the antenna directs in the command orientation direction at the initial capture, and
a drive command value calculator to calculate a drive command value indicating amounts by which the azimuth support, the elevation support, and the auxiliary support are driven so that (i) the antenna directs in the command orientation direction and (ii) a sum of amounts of change of the azimuth axis, the elevation axis, and the auxiliary axis from the respective original points is minimized.

6. A method for controlling an antenna device, the antenna device including an antenna to transmit an electromagnetic wave to a communication target and receive an electromagnetic wave from the communication target; an azimuth support to support the antenna rotatably around an azimuth axis; an elevation support to support the antenna rotatably around an elevation axis within an elevation axis rotation range, the elevation axis rotation range being predetermined; and an auxiliary support to support the antenna rotatably around an auxiliary axis within an auxiliary axis rotation range, the auxiliary axis rotation range being predetermined to be narrower than the elevation axis rotation range, the auxiliary axis being perpendicular to the elevation axis, the method comprising:
calculating a command orientation direction being a direction for the antenna instructed to be oriented, and being a direction in which the communication target exists;
at initial capture of the communication target, setting an original point of an auxiliary axis to a midpoint of the auxiliary axis rotation range and setting an original point of an azimuth axis and an original point of an elevation axis to an angle of rotation around the azimuth axis and an angle of rotation around the elevation axis, respectively, at which angles the antenna directs in the command orientation direction at the initial capture;
calculating a drive command value indicating amounts by which the azimuth support, the elevation support, and the auxiliary support are driven so that (i) the antenna directs in the command orientation direction and (ii) a sum of amounts of change of the azimuth axis, the elevation axis, and the auxiliary axis from the original point is minimized; and
controlling the azimuth support, the elevation support, and the auxiliary support in accordance with the drive command value.

7. The antenna device according to claim 2, further comprising a polarization angle changer to rotate the antenna or a radiator included in the antenna around a polarization axis that is perpendicular to the elevation axis and the auxiliary axis.

8. The antenna device according to claim 3, wherein
at the initial capture of the communication target, the original point setter sets an original point of a polarization axis to an angle of rotation around the polarization axis at which the antenna directs in the command orientation direction at the initial capture, and
the drive command value calculator calculates a drive command value indicating amounts by which the azimuth support, the elevation support, the auxiliary support, and the radiator are driven so that a sum of amounts of change of the azimuth axis, the elevation axis, the auxiliary axis, and the polarization axis from the respective original points is minimized.
